(19) United States
(12) Patent Application Publication
(10) Pub. No.: US 2023/0008706 A1
(43) Pub. Date: Jan. 12, 2023

(54) PARTICLES-BASED FLUID ANALYSIS SIMULATION METHOD USING DUMMY PARTICLES, AND FLUID ANALYSIS SIMULATION DEVICE

(71) Applicant: E8IGHT CO., LTD, Seongnam-si Gyeonggi-do (KR)

(72) Inventor: Kwang Joon CHO, Seongnam-si Gyeonggi-do (KR)

(73) Assignee: E8IGHT CO., LTD, Seongnam-si Gyeonggi-do (KR)

(21) Appl. No.: 17/784,666

(22) PCT Filed: Dec. 27, 2019
(86) PCT No.: PCT/KR2019/018574

§ 371 Date: Jun. 12, 2022

(30) Foreign Application Priority Data
Dec. 13, 2019 (KR) 10-2019-0166601

(51) Int. Cl. G06F 30/25

(52) U.S. Cl. CPC G06F 30/25

(57) ABSTRACT

A particle-based fluid analysis simulation method, which uses dummy particles and is performed in a fluid analysis simulation device, comprises the steps of: modeling a simulation area, including a plurality of particles, for a fluid; generating at least one dummy particle required for fluid analysis simulation of the simulation area, and arranging the at least one dummy particle outside the simulation area; calculating flow data of the plurality of particles by using the at least one dummy particle arranged on the outside; and performing the fluid analysis simulation of the simulation area on the basis of the calculation result, wherein the number of the at least one dummy particle is varied while the fluid analysis simulation is being performed.

### BACKGROUND OF THE DISCLOSURE

### Technical Field

The present invention relates to a particles-based fluid analysis simulation method using dummy particles, and a fluid analysis simulation device.

### Background Art

Computational fluid dynamics (CFD) as a field of fluid dynamics calculates a dynamic motion of a fluid using a computer in a numerical analytical method. The CFD calculates the flow of the fluid by discretizing a Naiver-Stokes Equation which is a partial differential equation through methods such as Finite Difference Method (FDM), Finite Element Method (FEM), Finite Volume Method (FVM), and Smoothed Particle Hydrodynamics (SPH).

There are two methods for calculating the Navier-Stokes equation: a lattice-based method that discretizes a spatial domain into a small mesh or lattice, and a particle-based method that expresses a fluid as a set of multiple particles.

In the particle-based method, a more natural simulation of natural or physical phenomena is possible by expressing an analysis target as particles instead of using a lattice. The particle-based method includes Smoothed Particle Hydrodynamics (SPH), Moving Particle Semi-implicit (MPS), Lattice Boltzmann Method (LBM), etc.

A Smoothed Particle Hydrodynamics (SPH)-based fluid analysis, which is one of the particle-based methods, can simulate the results of the analysis relatively quickly because the step of generating the grid is omitted, unlike the grid-based method.

In addition, since the SPH-based fluid analysis performs the analysis by using particles without generating the grid, analysis of free surfaces such as liquid-gas interfaces can be performed relatively easily.

Further, the SPH-based fluid analysis can perform relatively accurate analysis of multiphase flows including two or more of gas, liquid, and solid.

Due to the advantages, recently, SPH has been widely used in simulating the flow of the fluid.

The particle-based method finds a plurality of adjacent particles within a predetermined radius from one particle in order to calculate the flow of a plurality of particles representing a fluid, and calculates flow data with the adjacent particles. In this case, since there is no particle positioned near the boundary of the simulation region at the outside adjacent to the boundary, there are not enough adjacent particles, which causes a problem in calculating the flow data.

Hereinafter, the above-described problems will be described in detail with reference to FIG. 1.

FIG. 1 is a diagram for describing a conventional fluid analysis simulation process. In the case of calculating the flow of a plurality of particles using a particle-based method in the conventional computational fluid dynamics (CFD), a plurality of adjacent particles located within a predetermined radius from one reference particle located in the inner region of the simulation region are searched, and as a result, it is possible to calculate the flow between a particle and a plurality of adjacent particles.

Referring to FIG. 1, when the reference particle 100 is located near the boundary of the simulation region, such as near a wall of a structure, within a predetermined radius 110 from the reference particle 100, an outer region 130 is also included as well as the inner region 120 of the simulation region. For this reason, when the reference particle 100 is located near the boundary of the simulation region (near the wall of the structure), the number of a plurality of searched adjacent particles is just a half of the number of searched adjacent particles when the reference particle 100 is located in the inner region 120 of the simulation region.

In general, particle-based fluid analysis calculates the flow of the particle by considering physical force (i.e., force by density, force by pressure, and force by viscosity) which the reference particle receives from an adjacent particle thereto.

However, in the case of the particle located near the boundary, an error occurs in calculating the flow of the particle due to the absence of the adjacent particle.

Prior Art Document: Japanese Patent Registration No. 6009075

### SUMMARY OF THE DISCLOSURE

The present invention is contrived to solve the above-described problem, and the present invention has been made in an effort to provide a method and a device for fluid analysis simulation which enable accurate calculation of flow data even near a boundary of a simulation region to enable natural simulation.

However, a technical object to be achieved by the embodiment of the present invention is not limited to the technical objects and there may be other technical objects.

As a technical means for achieving the technical object, an embodiment of the present invention may provide a particles-based fluid analysis simulation method, which includes: modeling a simulation region including a plurality of particles for a fluid; generating at least one dummy particle required for fluid analysis simulation for the simulation region and arranging the generated dummy particle outside the simulation region; and calculating flow data of the plurality of particles by using at least one dummy particle arranged outside and performing the fluid analysis simulation on the simulation region based on the calculation result, in which the number of one or more dummy particles is varied while the fluid analysis simulation is performed.

Further, another embodiment of the present invention may provide a particles-based fluid analysis simulation device using dummy particles, which includes: a modeling unit modeling a simulation region including a plurality of particles for a fluid; a dummy particle arrangement unit generating at least one dummy particle required for fluid analysis simulation for the simulation region and arranging the generated dummy particle outside the simulation region; and a flow data calculation unit calculating flow data of the plurality of particles by using at least one dummy particle arranged outside and performing the fluid analysis simulation on the simulation region based on the calculation result, in which the number of one or more dummy particles is varied while the fluid analysis simulation is performed.

The problem solving means is just exemplary, and should not be interpreted as an intention of limiting the present invention. In addition to the above-mentioned exemplary embodiment, an additional embodiment may exist, which is disclosed in drawings and a detailed description of the present invention.

According to any one of the above-mentioned means for solving the problems of the present invention, a method and a device for fluid analysis simulation in which by arranging dummy particles outside the simulation region, even when the reference particle is located near the boundary of the simulation region (e.g., near the wall of the structure), a plurality of adjacent particles located within a predetermined radius of the reference particle which is a calculation target of the flow data can be searched.

By varying the number of at least one dummy particle while the fluid analysis simulation is being performed, it is possible to solve the problems of a decrease in calculation speed and inability to calculate due to an excess of an allowable number.

### BRIEF DESCRIPTION OF THE DRAWINGS

FIG. 1 is a diagram for describing a conventional fluid analysis simulation process.

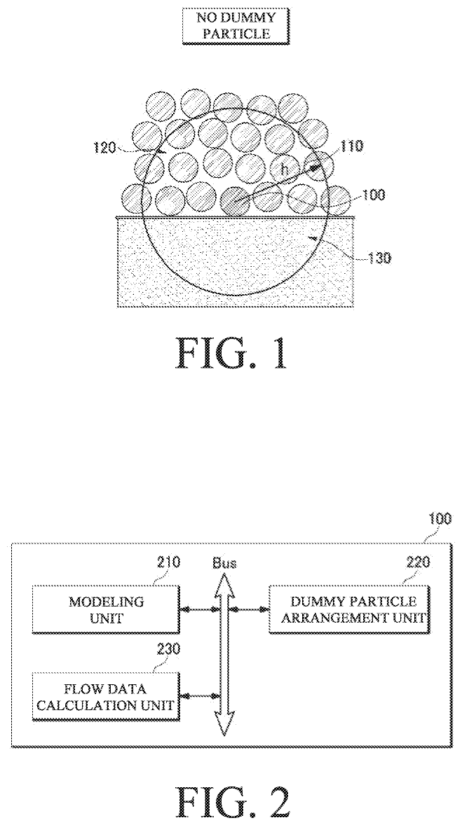

FIG. 2 is a block diagram illustrating a fluid analysis simulation device according to an embodiment of the present invention.

FIGS. 3A and 3B are exemplary diagrams for describing a process of calculating the flow of a plurality of particles by using a basic dummy particle according to an embodiment of the present invention.

FIGS. 4A and 4B are exemplary diagrams for describing a process of calculating the flow of a plurality of particles by using a basic dummy particle and an additional dummy particle according to an embodiment of the present invention.

FIG. 5 is a flowchart of a fluid analysis simulation method in a fluid analysis simulation device according to an embodiment of the present invention.

### DETAILED DESCRIPTION OF THE DISCLOSURE

Hereinafter, embodiments of the present invention will be described in detail so as to be easily implemented by those skilled in the art, with reference to the accompanying drawings. However, the present invention may be modified in various different ways, all without departing from the spirit or scope of the present invention. In addition, in the drawings, in order to clearly describe the present invention, a part not related to the description is omitted and like reference numerals designate like elements throughout the specification.

Throughout the specification, when it is described that a part is “connected” with another part, it means that the part may be “directly connected” with another part and the parts may be “electrically or mechanically connected” to each other with still another element interposed therebetween. Further, when a part “includes” a component, it means that other components may be further included, rather than excluding other components, unless otherwise stated, and it is to be understood that the existence or addition of one or more other features, numbers, steps, operations, components, parts, or combinations thereof is not precluded in advance.

In this specification, a “unit” includes a unit realized by hardware, a unit realized by software, and a unit realized using both. In addition, one unit may be implemented using two or more hardware, and two or more units may be implemented by one hardware.

Some of the operations or functions described as being performed by a terminal or device in this specification may be instead performed by a server connected to the terminal or device. Similarly, some of the operations or functions described as being performed by the server may also be performed in a terminal or device connected to the server.

Hereinafter, an embodiment of the present invention will be described in detail with reference to the accompanying drawings.

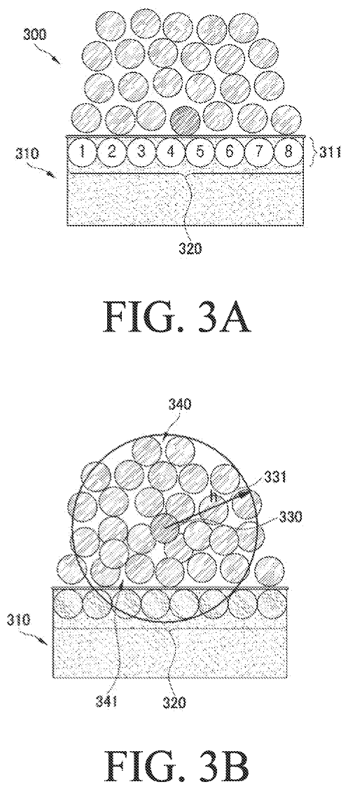

FIG. 2 is a block diagram illustrating a fluid analysis simulation device according to an embodiment of the present invention. Referring to FIG. 2, the fluid analysis simulation device 100 may include a server, a desktop, a notebook computer, a KIOSK, and a smartphone, and a tablet PC. However, the fluid analysis simulation device 100 is not limited to the exemplified devices above. That is, the fluid analysis simulation device 100 may include all devices equipped with a processor for performing an SPH-based fluid analysis simulation method to be described later.

The fluid analysis simulation device 100 performs a three-dimensional flow analysis of the fluid. That is, the fluid analysis simulation device 100 models a three-dimensional simulation region and a plurality of particles positioned in the three-dimensional simulation region, and analyzes the flow of the plurality of particles in the three-dimensional simulation region. However, in the present specification, for convenience of description, the simulation region and particles are expressed and described in two dimensions.

The fluid analysis simulation device 100 may perform a simulation for analyzing a fluid based on smoothed particle hydrodynamics (SPH). The Smoothed Particle Hydrodynamics (SPH) is one of the particle-type fluid analysis techniques which may be used in Computational Fluid Dynamics (CFD). In order to simulate the motion of the fluid, the SPH may express a fluid to be analyzed as one or more particles. The SPH may calculate a physical quantity of each particle while tracking each particle, and perform the fluid analysis simulation based on the calculation result.

The fluid analysis simulation method according to the present invention includes, but is not limited to, an application field in which a fluid analysis simulation is calculated in real time, and is also applied to various application fields requiring fluid analysis simulation.

Exemplary application fields include, for example, computer games, medical simulations, scientific applications, and computer animation. The fluid analysis simulation device 100 may include a modeling unit 210, a dummy particle arrangement unit 220, and a flow data calculation unit 230.

The modeling unit 210 may model a simulation region including a plurality of particles for a fluid. For example, the modeling unit 210 may receive at least one of terrain information, structure information, boundary condition information, particle physical property information, and gravitational acceleration information from a user using a keyboard, a mouse, a joystick, a touch screen, and a microphone, and model the simulation region based on at least one received information.

Here, the structure information may include at least one of a density, a coefficient of restitution, and a coefficient of friction.

In addition, the particle physical property information may include at least one of a particle radius, a density, a viscosity, a speed of sound, and an initial velocity.

The dummy particle arrangement unit 220 may generate at least one dummy particle required for fluid analysis simulation for the simulation region and arrange the generated dummy particle outside the simulation region. For example, the dummy particle arrangement unit 220 may generate a plurality of basic dummy particles to be arranged outside the simulation region, and may arrange the generated at least one basic dummy particle in the simulation region. Here, the at least one dummy particle may include direction information required for generating the at least one additional dummy particle.

The flow data calculation unit 230 may determine a reference particle that is a calculation target of flow data among a plurality of particles for the fluid, and search for a plurality of adjacent particles located within a predetermined search radius from the determined reference particle.

The flow data calculation unit 230 may calculate the flow data of the plurality of particles by using at least one dummy particle arranged outside. For example, the flow data calculation unit 230 may calculate the flow of the plurality of particles by using a plurality of basic dummy particles arranged outside.

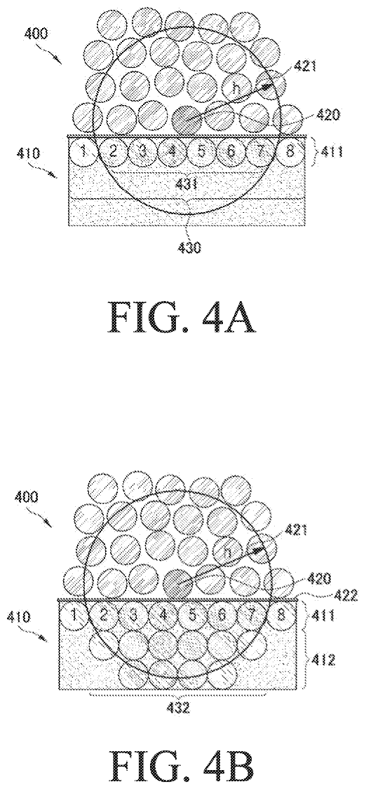

A process of calculating the flow of the plurality of particles using the basic dummy particle will be described with reference to FIGS. 3A and 3B for a moment.

FIGS. 3A and 3B are exemplary diagrams for describing a process of calculating the flow of a plurality of particles by using a basic dummy particle according to an embodiment of the present invention.

Referring to FIG. 3A, when the modeling unit 210 models the simulation region 300 including the plurality of particles for the fluid, the dummy particle arrangement unit 220 may generate a plurality of basic dummy particles 320 to be arranged at an outside 310 of the simulation region 300, and arrange at least one generated basic dummy particle 320 in a first outer region 311 adjacent to a boundary of the simulation region 300. For example, the dummy particle arrangement unit 220 may arrange the basic dummy particle 320 in the first outer region 311 adjacent to all boundaries of the simulation region 300.

Referring to FIG. 3B, the flow data calculation unit 230 may determine a reference particle 330 that is a calculation target of the flow data among the plurality of particles for the fluid, and search for a plurality of adjacent particles 340 located within a predetermined search radius 331 from the determined reference particle 330.

The flow data calculation unit 230 uses the plurality of basic dummy particles 320 arranged in the outside 310 to calculate the flow of the plurality of particles for an inner region 341 (a boundary region of the simulation region and the outer region) in the simulation region 300.

According to the present invention, even when the reference particle 330 is located near the boundary of the simulation region like a structure, the fluid analysis simulation may be accurately expressed.

Considering the search radius of the reference particle 330, the dummy particles are required to be arranged in two to three layers near the boundary of the simulation region.

However, when numerous dummy particles are arranged in the outer region of the simulation region, a calculation speed is lowered, and the flow of particles becomes impossible to calculate due to the excess of the allowable number of dummy particles.

Accordingly, in the present invention, the number of dummy particles required to perform the fluid analysis simulation is variably arranged.

Referring back to FIG. 2, the dummy particle arrangement unit 220 may generate at least one additional dummy particle to be arranged outside the simulation region, and arrange the generated at least one additional dummy particle outside the simulation region.

The flow data calculation unit 230 may calculate the flow of the plurality of particles by using the plurality of basic dummy particles arranged outside and at least one additional dummy particle.

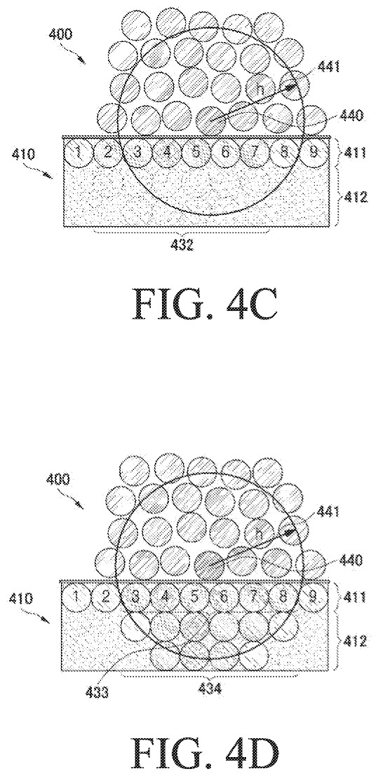

A process of calculating the flow of the plurality of particles using the basic dummy particle and the additional dummy particle will be described with reference to FIGS. 4A to 4D for a moment.

Referring to FIG. 4A, the flow data calculation unit 230 may determine a reference particle 420 that is a calculation target of the flow data among the plurality of particles for the fluid, and search for a plurality of adjacent particles located within a predetermined search radius 421 from the determined reference particle 420.

The dummy particle arrangement unit 220 may generate at least one additional dummy particle and arranged the generated additional dummy particle in an outer region 410 of a simulation region 400 when the plurality of searched adjacent particles includes a first basic dummy particle 431 that is one of the plurality of basic dummy particles 430.

In this case, the dummy particle arrangement unit 220 may sequentially generate and arrange at least one additional dummy particle in the order in which second to seventh particles are located among the first basic dummy particles 431 or generate and arrange at least one additional dummy particle corresponding to the positions of the second to seventh particles at a time.

Referring to FIG. 4B, the dummy particle arrangement unit 220 may generate at least one additional dummy particle 432 to be arranged in a second outer region 412 adjacent to the first outer region 411, and arrange the generated at least one additional dummy particle 432 in the second outer region 412 when the plurality of searched adjacent particles includes the first basic dummy particle 431 which is one of the basic dummy particles 430. Here, the dummy particle arrangement unit 220 may arrange at least one additional dummy particle 432 based on a direction from a boundary 422 toward the basic dummy particle 431 and a diameter of the basic dummy particle 431.

The flow data calculation unit 230 may calculate the flow of the reference particle 430 by using the first basic dummy particle 431 and at least one additional dummy particle 432.

Referring to FIG. 4C, after the calculation of the flow data of the reference particle 420 is completed, the flow data calculation unit 230 may re-determine other reference particles 440 that are the calculation target of the flow data among the plurality of particles, and re-search for a plurality of adjacent particles located within a predetermined radius 421 from the re-determined other particles 441.

The dummy particle arrangement unit 220 may remove at least one additional dummy particle 432. For example, the dummy particle arrangement unit 220 may remove all of the at least one additional dummy particle 432 generated based on the reference particle 420 of FIG. 4A. As another example, some of the at least one additional dummy particle 432 generated based on the reference particle 420 of FIG. 4A are not included in the other additional dummy particle 434 generated based on the other reference particles 440 in FIG. 4D, the dummy particle arrangement unit 220 may also remove only at least one additional dummy particle 432 which is not included.

Here, the at least one additional dummy particle 432 may also be automatically removed as the calculation of the flow of the reference particle 430 is completed.

Referring to FIG. 4D, the dummy particle arrangement unit 220 may generate at least one additional other dummy particle 434 to be arranged in the second outer region 412 adjacent to the first outer region 411, and arrange the generated at least one other additional dummy particle 434 in the second outer region 412 when the plurality of re-searched adjacent particles includes the second basic dummy particle 433 which is one of the plurality of basic dummy particles 430.

In this case, the other additional dummy particle 434 may be generated and arranged while the flow data calculation unit 230 calculates the flow of the reference particle 430 by using the first basic dummy particle 431 and at least one additional dummy particle 432.

The flow data calculation unit 230 may calculate the flow of the other reference particles 440 by using the second basic dummy particle 433 and at least one other additional dummy particle 434.

Referring back to FIG. 2, the flow data calculation unit 230 may perform the fluid analysis simulation for the simulation region based on the calculation result.

Specifically, the flow data calculation unit 230 may calculate flow data generated due to a collision between each particle and the neighboring particle or a collision between each particle and a polygon constituting a structure model by using the SPH algorithm, and perform the fluid analysis simulation based on the flow data.

The SPH algorithm calculates the flow of each particle using property information (e.g., mass, velocity, viscosity, and acceleration) of each particle, and the property information of each particle is interpolated by using a kernel function set such as a radial basis function around the location of the each particle.

When the property information of each particle is interpolated by such a scheme, continuous fields such as pressure and viscosity fields that may be used to calculate the dynamics of a fluid are generated by using standard equation such as the Navier-Stokes Equation.

For example, the Navier-Stokes equation models the fluid as follows.

$$ρ ( ( \frac{\partial v}{\partial t} ) + v \cdot ∇ v ) = ρ g - ∇ p + μ {∇}^{2} v \qquad [ Equation 1 ]$$

In Equation 1, “v” represents the velocity of the particle, “ρ” represents the density of the particle, “p” represents the pressure on the particle, “g” represents the gravity, and “μ” represents the viscosity coefficient of the fluid.

Meanwhile, according to the SPH algorithm, the density of each particle is derived by Equation 2.

$$ρ ( {x}_{i} ) = {\sum }_{i} {m}_{j} W ( {x}_{i} - {x}_{j} , h ) \qquad [ Equation 2 ]$$

Further, force by the pressure of each particle is derived by Equation 3.

$${f}_{i}^{pressure} = - {\sum }_{j} {m}_{j} \frac{{p}_{i} + {p}_{j}}{2 {ρ}_{j}} ∇ W ( {x}_{i} - {x}_{j} , h ) \qquad [ Equation 3 ]$$

Further, force by the viscosity of each particle is derived by Equation 4.

$${f}_{i}^{viscosity} = μ {\sum }_{j} {m}_{j} \frac{{v}_{j} - {v}_{i}}{{ρ}_{j}} {∇}^{2} W ( {x}_{i} - {x}_{j} , h ) \qquad [ Equation 4 ]$$

The flow data calculation unit 230 calculates change values of the flow data such as the density, the pressure, and the viscosity, of each particle by using the SPH algorithm. For example, the flow data calculation unit 230 calculates the flow data of each particle in a next time step (a first time step) based on initial flow data of each particle, and calculates the flow of each particle based thereon.

Further, the flow data calculation unit 230 calculates the flow data of each particle in a next time step based on the flow data of each particle in the first time step, and calculates the flow of each particle based thereon.

The flow data calculation unit 230 may perform the fluid analysis simulation by calculating the flow of each particle by calculating the flow data of each particle in each time step.

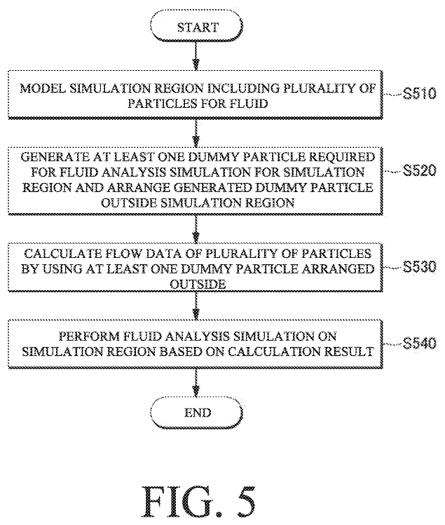

FIG. 5 is a flowchart of a fluid analysis simulation method using a dummy particle in a fluid analysis simulation device according to an embodiment of the present invention. The fluid analysis simulation method using the dummy particle according to an embodiment illustrated in FIG. 5 includes steps that are processed in time series by the fluid analysis simulation device illustrated in FIG. 2. Accordingly, even contents omitted below are also applied to the fluid analysis simulation method using the dummy particle performed according to the embodiment illustrated in FIG. 5.

In step S510, the fluid analysis simulation device may model a simulation region including a plurality of particles for a fluid.

In step S520, the fluid analysis simulation device may generate at least one dummy particle required for fluid analysis simulation for the simulation region and arrange the generated dummy particle outside the simulation region.

In step S530, the fluid analysis simulation device may calculate the flow data of the plurality of particles by using at least one dummy particle arranged outside.

In step S540, the fluid analysis simulation device may perform the fluid analysis simulation on the simulation region based on the calculation result.

In the above description, steps S510 to S540 may be further divided into additional steps or combined into fewer steps, according to an embodiment of the present invention. In addition, some steps may be omitted as necessary, and the order between the steps may be switched.

The fluid analysis simulation method described with reference to FIG. 5 may be implemented in the form of a computer program stored in a medium, or may be implemented in the form of a recording medium including instructions executable by a computer, such as a program module executed by a computer. A computer readable medium may be a predetermined available medium accessible by the computer or includes all of volatile and non-volatile media and removable and irremovable media. Further, the computer readable medium may include a computer storage medium. The computer storage medium includes all of the volatile and non-volatile and removable and irremovable media implemented by a predetermined method or technology for storing information such as a computer readable command, a data structure, a program module, or other data.

The aforementioned description of the present invention is used for exemplification, and it can be understood by those skilled in the art that the present invention can be easily modified in other detailed forms without changing the technical spirit or requisite features of the present invention. Therefore, it should be appreciated that the aforementioned embodiments are illustrative in all aspects and are not restricted. For example, respective constituent elements described as single types can be distributed and implemented, and similarly, constituent elements described to be distributed can also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

1. A particles-based fluid analysis simulation method using dummy particles, which is performed by a fluid analysis simulation device, the method comprising:
modeling a simulation region including a plurality of particles for a fluid;
generating at least one dummy particle required for fluid analysis simulation for the simulation region and arranging the generated dummy particle outside the simulation region; and
calculating flow data of the plurality of particles by using at least one dummy particle arranged outside and performing the fluid analysis simulation on the simulation region based on the calculation result,
wherein the number of one or more dummy particles is varied while the fluid analysis simulation is performed.

2. The particles-based fluid analysis simulation method of claim 1, wherein the arranging of the dummy particle includes
generating a plurality of basic dummy particles to be arranged outside in the simulation region, and
arranging the at least one generated basic dummy particle in a first outer region adjacent to a boundary of the simulation region, and
the performing of the fluid analysis simulation includes calculating the flow of the plurality of particles for an inner region in the simulation region by using the plurality of basic dummy particles arranged outside.

3. The particles-based fluid analysis simulation method of claim 2, wherein the performing of the fluid analysis simulation includes
determining a reference particle which is a calculation target of the flow data among the plurality of particles for the fluid, and
searching for a plurality of adjacent particles located within a predetermined search radius from the determined reference particle.

4. The particles-based fluid analysis simulation method of claim 3, wherein the performing of the fluid analysis simulation further includes
when the plurality of searched adjacent particles includes a first basic dummy particle which is one of the plurality of basic dummy particles, generating at least one additional dummy particle to be arranged in a second outer region adjacent to the first outer region,
arranging the at least one generated additional dummy particle in the second outer region, and
calculating the flow of the reference particle by using the first basic dummy particle and the at least one additional dummy particle.

5. The particles-based fluid analysis simulation method of claim 4, further comprising:
re-determining other reference particles that are calculation targets of flow data among the plurality of particles when the calculation of the flow data of the reference particle is completed, and
re-searching for a plurality of adjacent particles located within a predetermined radius from the re-determined other reference particles.

6. The particles-based fluid analysis simulation method of claim 5, wherein the performing of the fluid analysis simulation includes
when the plurality of re-searched adjacent particles includes a second basic dummy particle which is one of the plurality of basic dummy particles, generating at least one other additional dummy particle to be arranged in the second outer region, and
arranging the at least one other generated additional dummy particle in the second outer region, and
calculating the flow of the other reference particles by using the second basic dummy particle and the at least one other additional dummy particle.

7. The particles-based fluid analysis simulation method of claim 4, wherein the generating of the at least one additional dummy particle includes arranging the at least one additional dummy particle based on a direction from the boundary toward the basic dummy particle and a diameter of the basic dummy particle.

8. The particles-based fluid analysis simulation method of claim 4, wherein the at least one dummy particle includes direction information required for generating the at least one additional dummy particle.

9. The particles-based fluid analysis simulation method of claim 1, wherein the modeling of the simulation region includes
receiving at least one of terrain information, structure information, boundary condition information, particle physical property information, and gravitational acceleration information, and
modeling the simulation region based on the at least one received information.

10. The particles-based fluid analysis simulation method of claim 9, wherein the structure information includes at least one of a density, a coefficient of restitution, and a coefficient of friction.

11. The particles-based fluid analysis simulation method of claim 9, wherein the particle physical property information includes at least one of a particle radius, a density, a viscosity, a speed of sound, and an initial velocity.

12. A particles-based fluid analysis simulation device using dummy particles, the device comprising:
a modeling unit modeling a simulation region including a plurality of particles for a fluid;
a dummy particle arrangement unit generating at least one dummy particle required for fluid analysis simulation for the simulation region and arranging the generated dummy particle outside the simulation region; and
a flow data calculation unit calculating flow data of the plurality of particles by using at least one dummy particle arranged outside and performing the fluid analysis simulation on the simulation region based on the calculation result,
wherein the number of one or more dummy particles is varied while the fluid analysis simulation is performed.

13. The particles-based fluid analysis simulation device of claim 12, wherein the dummy particle arrangement unit generates a plurality of basic dummy particles to be arranged outside in the simulation region, and arranges the at least one generated basic dummy particle in a first outer region adjacent to a boundary of the simulation region, and
the flow data calculation unit calculates the flow of the plurality of particles for an inner region in the simulation region by using the plurality of basic dummy particles arranged outside.

14. The particles-based fluid analysis simulation device of claim 13, wherein the flow data calculation unit determines a reference particle that is a calculation target of flow data among a plurality of particles for the fluid, and searches for a plurality of adjacent particles located within a predetermined search radius from the determined reference particle.

15. The particles-based fluid analysis simulation device of claim 14, wherein when the plurality of searched adjacent particles includes a first basic dummy particle which is one of the plurality of basic dummy particles, the dummy particle arrangement unit generates at least one additional dummy particle to be arranged in a second outer region adjacent to the first outer region, and arranges the at least one generated additional dummy particle in the second outer region, and
the flow data calculation unit calculates the flow of the reference particle by using the first basic dummy particle and the at least one additional dummy particle.

16. The particles-based fluid analysis simulation device of claim 15, wherein the flow data calculation unit re-determines other reference particles that are calculation targets of flow data among the plurality of particles when the calculation of the flow data of the reference particle is completed, and re-searches for a plurality of adjacent particles located within a predetermined radius from the re-determined other reference particles.

17. The particles-based fluid analysis simulation device of claim 16, wherein when the plurality of re-searched adjacent particles includes a second basic dummy particle which is one of the plurality of basic dummy particles, the dummy particle arrangement unit generates at least one other additional dummy particle to be arranged in the second outer region, and arranges the at least one other generated additional dummy particle in the second outer region, and
the flow data calculation unit calculates the flow of the other reference particles by using the second basic dummy particle and the at least one other additional dummy particle.

18. The particles-based fluid analysis simulation device of claim 15, wherein the flow data calculation unit arranges the at least one additional dummy particle based on a direction from the boundary toward the basic dummy particle and a diameter of the basic dummy particle.

19. A computer readable recording medium having a program which allows a computing device to execute a method recorded in claim 1, which is recorded therein.
